(19) United States
(12) Patent Application Publication
(10) Pub. No.: US 2014/0270080 A1
(43) Pub. Date: Sep. 18, 2014

(54) Electrochemical Test Cell For Enabling In-Situ X-Ray Diffraction and Scattering Studies of Scale Formation and Microstructural Changes in Materials with Flow Through Solution

(71) Applicant: LAWRENCE LIVERMORE NATIONAL SECURITY, LLC, (US)

(72) Inventors: Bassem S. EL-DASHER, Livermore, CA (US); Joseph C. FARMER, Tracy, CA (US); Samuel TORRES, Livermore, CA (US); Sharon G. TORRES, Livermore, CA (US)

(21) Appl. No.: 13/841,527

(22) Filed: Mar. 15, 2013

(51) Int. Cl. G01N 23/201

(52) U.S. Cl. CPC G01N 23/201
USPC 378/86

(57) ABSTRACT

An electrochemical test cell apparatus is disclosed for enabling in-situ X-ray transmission of a flowing fluid using a small angle X-ray scattering technique. A base has a recessed portion that partially defines a volume for containing a test sample. The base may have a fluid supply passage for providing a flowing fluid into the volume, a fluid return passage for allowing the flowing fluid to exit the volume and flow out of the test cell, and a first hole for allowing an X-ray beam to pass through the volume. A clamp member is coupled to the base to help define the volume and may have a second hole aligned with the first hole that allows the X-ray beam to pass through the clamp member. A pair of material portions may be clamped between the base and the clamp member to retain the fluid within the volume while allowing passage of the X-ray beam through first and second holes. A pair of electrodes may be used to supply a potential difference to the flowing fluid.

### STATEMENT OF GOVERNMENT RIGHTS

The United States Government has rights in this invention pursuant to Contract No. DE-AC52-07NA27344 between the U.S. Department of Energy and Lawrence Livermore National Security, LLC, for the operation of Lawrence Livermore National Laboratory.

### FIELD

The present disclosure relates to electrochemical test cells, and more particularly to an electrochemical test cell that enables in-situ X-ray diffraction studies of a fluid flowing through the test cell.

### BACKGROUND

The statements in this section merely provide background information related to the present disclosure and may not constitute prior art.

The co-inventors of the subject matter of the present disclosure initially desired to study the formation of hydrogen bubbles in metals during an electrochemical process known as cathodic hydrogen charging. There was an initial interest and intention of using small angle x-ray scattering techniques (SAXS) at synchrotron sources to provide information about this process. However, SAXS techniques require the beam to go through the sample being studied (known as the “transmission technique”).

During investigative follow up work searching of literature involving this technology, it became apparent that the majority of prior electrochemical cells developed for synchrotron use were designed for reflection techniques such as diffraction and would not work for an application where a liquid would be flowing past an electrode being studied. With previously developed systems, the effort put into a transmission cell was primarily for static designs that did not have the complexity of flowing the liquid past the electrode being studied. Flowing the liquid past the electrode is required to either correctly simulate real-life conditions or to clear the beam path from bubbles that form during the breakdown of the electrolyte.

One previously developed design that was reviewed did involve a flowing liquid. However, with that design, the need to flow the electrolyte across both sides of the working sample was accommodated by putting the counter electrode in the path of the beam across from the working electrode. This design thus required only needing to expose one side of the working electrode. One potential limitation that arises with this arrangement is that leakage behind the working sample affects the electrochemical data, making the measurements difficult to interpret at best. A more challenging issue is that the beam path includes the counter electrode. This results in contaminating the data obtained by scattering from that electrode as well, since only scattering from the working electrode is what is sought after.

### SUMMARY

In one aspect the present disclosure relates to a electrochemical test cell apparatus for enabling in-situ X-ray transmission of a flowing fluid using a small angle X-ray scattering technique. The apparatus may comprise a base having a recessed portion that partially defines a volume for containing a test sample. The base may have a fluid supply passage for providing a flowing fluid into the volume, a fluid return passage for allowing the flowing fluid to exit the volume and flow out of the test cell, and a first hole for allowing an X-ray beam to pass through the volume. A clamp member may be configured to be sealingly coupled to the base to help define the volume in which the test sample is positioned. The clamp member may have a second hole aligned with the first hole in the base for allowing the X-ray beam to pass through the clamp member. The first and second material portions may be configured to be clamped between the base and the clamp member adjacent the volume to retain the fluid within the volume while allowing passage of the X-ray beam through first and second holes and the volume. A pair of electrodes may be in communication with flowing fluid contained in the base which supply a potential difference to the flowing fluid.

In another aspect the present disclosure relates to an electrochemical test cell apparatus for enabling in-situ X-ray transmission of a flowing fluid using a small angle X-ray scattering technique. The apparatus may comprise a base having a recessed portion that partially defines a volume for containing a test sample. The base may have a fluid supply reservoir for receiving and containing a portion of a flowing fluid, a fluid supply passage in communication with the fluid supply reservoir for channeling the flowing fluid from the fluid supply reservoir into the volume, and a fluid return reservoir. A fluid return passage may also be included in the base which is in communication with the fluid return reservoir for allowing the flowing fluid to exit the volume and flow out to the fluid return reservoir. A first hole may be provided for allowing an X-ray beam to pass through the volume. A clamp member may be configured to be sealingly coupled to the base to help define the volume in which the test sample is positioned. The clamp member may have a second hole aligned with the first hole in the base for allowing the X-ray beam to pass through the clamp member. First and second material portions may be clamped between the base and the clamp member adjacent the volume to retain the flowing fluid within the volume while allowing passage of the X-ray beam through first and second holes and the volume. A pair of electrodes may be positioned to extend into the fluid supply reservoir and the fluid return reservoir, which supply a potential difference to the flowing fluid.

In still another aspect the present disclosure relates to a method for in-situ X-ray transmission through a flowing fluid and a test sample using a small angle X-ray scattering technique. The method may comprise flowing a fluid into a test cell having a cavity formed therein for containing the test sample. The cavity may further include openings through which an X-ray beam may pass to irradiate the flowing fluid while the X-ray beam passes through the test sample. A potential difference may be applied to the flowing fluid as it enters the test cell. The flowing fluid may be directed through the interior cavity, over the test sample positioned within the cavity, and out from the test cell. Material sections may be used which are placed adjacent the cavity that permit passage of the X-ray beam through the cavity and the test sample while sealing the cavity against leakage of the flowing fluid out from the cavity as it flows through the test cell.

Other areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of one embodiment of a test cell in accordance with the present disclosure;

FIG. 2 is a perspective view of the test cell of FIG. 1 but with a clamp portion removed to better expose a test sample positioned in the test cell;

FIG. 3 is an exploded perspective view of the test cell;

FIG. 4 is a plan view of one of the transparent material sections used to seal the volume within the test cell;

FIG. 5 a plan view of one of the spacers used to help direct the flowing fluid over a central area of the test sample positioned within the volume;

FIG. 6 is a view of an inside surface of the clamp member;

FIG. 7 is a plan view of the base member illustrating the fluid supply and fluid return reservoirs;

FIG. 8 is a side cross sectional view of the base member in accordance with section line 8-8 in FIG. 7 illustrating the supply flow passages; and

FIG. 9 is a side view of an inside surface of the base that better illustrates the fluid supply and fluid return ports that communicate with the fluid supply and fluid return reservoirs in the base member.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIG. 1 there is shown an electrochemical test cell apparatus 10 (hereinafter “test cell” 10) well adapted for use with small angle X-ray scattering (SAXS) studies on a flowing liquid performed at a synchrotron source. The test cell 10 overcomes the disadvantages of previously designed test cells by enabling the scattering studies to be performed with a flowing fluid rather than a static fluid, and while enabling the X-ray beam to go through a test sample engulfed on both sides in the fluid within the test cell 10.

In FIG. 1, the test cell 10 may include a top member 12, a base 14 and a clamp member 16. The top member 12 may have an opening to receive a first threaded fitting 18 that houses a first electrode 18a, which is coupled to a first electrical conductor 20 that provides current to the first electrode 18a. Another opening may receive a second threaded fitting 22 that houses a second electrode 22a, which is coupled to a second electrical conductor 24. One of the electrodes 18a or 22a is a “counter” electrode while the other is a reference electrode.

The top member 12 has another opening that receives a threaded fitting 26 associated with a fluid return line 28, and still another opening that receives a threaded fitting 30 associated with a fluid supply line 32. The top member 12 may be secured to the base 14 by a plurality of threaded fasteners 34 extending through suitable openings and into engagement with threaded blind holes in the base 14. The clamp member 16 may be secured to the base 14 by a plurality of threaded fasteners 36 that extend through openings and into threaded blind holes in the base 14. An opening 38 in the clamp member 16 enables an X-ray beam 39 to pass through the clamp member 16 and irradiate a fluid, in this example an electrolyte, which is flowing through the test cell 10. The electrolyte may be supplied into the test cell 10 via the supply line 32 and may exit the test cell via the return line 28. A working electrode extension 40 extends from between the base 14 and the clamp member 16 to enable an electrical connection to be made to a metallic test sample 42, the “working” electrode, (not visible in FIG. 1) within the test cell 10 over which the electrolyte is flowing. And while the top member 12 is shown as accommodating only two electrodes 18a, 22a and two fluid lines 28,32, it will be appreciated that the dimensions of the test cell 10 could be enlarged to accommodate additional ports for interfacing other devices (e.g., pH sensor, temperature sensor, etc.) to the test cell.

Referring to FIG. 2, the test cell 10 can be seen in a partially disassembled condition. The test cell 10 houses the test sample 42, i.e., the “working” electrode, which is electrically connected to the working electrode extension 40 and which is exposed to the flowing electrolyte and to the X-ray beam. The test sample 42 resides in an interior cavity or volume formed in part by a recess 44 in the base 14 and in part by a similarly shaped recess 46 in the clamp member 16. FIG. 2 shows a spacer 74 positioned in the recess 46, which will be discussed further in the following paragraphs. A gasket 48 helps to seal the clamp member 16 to the base 14 to prevent leaking of the electrolyte. Small oval cushions 50, positioned in recesses 52, also act as gaskets and help center the test sample 42 within the recess 44 but more importantly prevents a potential leak path along the working electrode extension 40. The gasket 48 and cushions 50 may be made from any suitable materials that are highly resistant to corrosive fluids. In one form the gaskets 48 and cushions 50 are made from Viton® fluoroelastomer, which is known for its excellent heat resistance and resistance to corrosive chemicals.

FIG. 3 illustrates another exploded perspective view of the test cell 10 in its fully disassembled state. A gasket 54, also preferably made from Viton® fluoroelastomer, seals the top member 12 to the base 14, and a gasket 56 seals an upper surface 58 of the clamp member 16 to a lower surface 60 of the base 14. The base 14 can also be seen to include a pair of elongated reservoirs 62 and 64. In this example reservoir 62 forms a return reservoir that holds a quantity of electrolyte that is flowing out of the test cell 10, while reservoir 64 forms a supply reservoir for holding a quantity of electrolyte flowing into the test cell 10. The electrode 22a housed within fitting 22 is positioned in the electrolyte in the supply reservoir 64, while the electrode 18a housed within fitting 18 is positioned in the electrolyte within the return reservoir 62. An additional quantity of threaded fasteners 36a engage within blind holes (not shown) in the lower surface 60 of the base 14 to secure the upper surface 58 of the clamp member 16 to the lower surface 60 of the base 14.

With further reference to FIG. 3, the base 14 can also be seen to include a blind hole 66 that is aligned with the hole 38. Hole 38 and hole 66 permit the X-ray beam 39 to travel completely through the volume defined by the recesses 44 and 46 and through the entire test cell 10. A pair of identical, X-ray transparent, planar material sections 68 and 70, which in one form each are made from Kapton® film, and in another form, PEEK film, form windows that allow the X-ray beam 39 to pass completely through while acting as seals to retain the electrolyte flowing within the volume defined by recesses 44 and 46. Spacers 72 and 74 have openings that align with holes 38 and 66 and help to maintain the proper volume of electrolyte flowing through the test cell 10. The spacers also help direct the flowing electrolyte back to the return reservoir 62 and aid in removal of bubbles from the test sample 42 (the region that is being studied using the synchrotron).

With brief reference to FIG. 4, transparent material section 68 is shown in greater detail. A hole 76 is provided to allow a return flow of electrolyte to pass through the X-ray transparent material section 68 as it leaves the volume defined by recesses 44 and 46 and flows to the return reservoir 62. A hole 78 is provided to allow the electrolyte to flow from the supply reservoir 64 into the volume (i.e., cavity) defined by the recesses 44 and 46. As noted above, material section 68 is identical to material section 70, and as such also includes holes 76 and 78.

With brief reference to FIG. 5, spacer 72 is shown. Spacer 72 is identical to spacer 74 and includes a centrally formed opening 80 and elongated slot portions 82 and 84. Opening 80 provides a path for the X-ray beam 39 to pass through unaffected. Elongated slot portion 82 is in communication with openings 76 in the transparent material sections 68 and 70 to thus pass flowing electrolyte from the volume defined by recesses 44 and 46 into the return reservoir 62. Elongated slot portion 84 is in communication with the holes 78 and with the fluid supply reservoir 64, which allows the flowing electrolyte to enter the volume defined by recesses 44 and 46 where test sample 42 is located.

With further reference to FIGS. 3 and 6, the clamp member 16 also includes a fluid return passage 86 (FIG. 3) and a fluid supply passage 88 (FIG. 3). The fluid return passage 86 is in communication, with a fluid return port 90 (FIG. 6) in the clamp member 16. A fluid supply port 92 is in communication with fluid supply passage 88 (FIG. 3) in the clamp member 16. Ports 90 and 92 are thus in communication with the volume formed by the recesses 44 and 46 where the test sample 42 is positioned. Fluid from the supply reservoir 64 is thus able to flow through fluid supply passage 88 and through supply port 92, while fluid is able to flow out through return port 90 into fluid return passage 86 and back to the return reservoir 62.

Referring to FIGS. 7 and 8, the base 14 can be seen in greater detail. The fluid supply reservoir 64 includes a pair of fluid supply passages 94a and 94b while the fluid return reservoir 62 includes a pair of fluid return passages 96a and 96b. Fluid supply passage 94b is in communication with supply passage 88 in the clamp member 16. Fluid return passage 96b is in communication with return passage 86 in the clamp member 16.

With reference to FIGS. 7 and 9, fluid supply passage 94a is in communication with a fluid supply port 98 that opens into recess 44, and thus electrolyte is able to flow from the fluid supply reservoir 64, through passage 94a, and through port 98 to wet the test sample 42, the “working” electrode. Fluid return passage 96a (FIG. 7) is in communication with a fluid return port 100 that allows the return of electrolyte from the volume defined by recesses 44 and 46, through the return port 100, through the return passage 96a and into the fluid return reservoir 62. Thus, the fluid supply passages 94a and 94b are arranged such that they direct the electrolyte into the volume formed by recesses 44 and 46 on opposite sides of the test sample 42, the “working” electrode, while the return flow passages 96a and 96b are configured to receive the electrolyte flowing on opposite sides of the test sample.

The materials used to make the base 14, the clamp member 16 and the top member 12 should be electrically non-conductive and chemically resistant to the electrolyte. One such material that is suitable for use is PEEK, an organic polymer thermoplastic having excellent mechanical and chemical resistance properties. The fasteners 34, 36 and 36a similarly should be made from electrically non-conductive and chemically resistant materials.

The test cell 10 is expected to be used with a suitable pump, for example a peristaltic pump, for pumping the electrolyte through the test cell. A commercially available electrochemical potentiostat (preferably with computer control) may be used to apply and control the voltage potential applied across the electrodes 18a, 22a housed within fittings 18 and 22 respectively, and the working electrode extension 40. The test cell 10 thus forms an in-situ, flow through X-ray transmission three electrode electrochemical cell that is well adapted for liquid scattering studies at a synchrotron source.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. An electrochemical test cell apparatus for enabling in-situ X-ray transmission of a flowing fluid using a small angle X-ray scattering technique, the apparatus comprising:
a base having a recessed portion that partially defines a volume for containing a test sample, the base having:
a fluid supply passage for providing a flowing fluid into the volume;
a fluid return passage for allowing the flowing fluid to exit the volume and flow out of the test cell;
a first hole for allowing an X-ray beam to pass through the volume and the test sample;
a clamp member configured to be sealingly coupled to the base to help define the volume in which the test sample is positioned, the clamp member having a second hole aligned with the first hole in the base for allowing the X-ray beam to pass through the clamp member;
material configured to be clamped between base and clamp member adjacent the volume to retain the flowing fluid within the volume while allowing passage of the X-ray beam through the first and second holes and the volume; and
a pair of electrodes in communication with the flowing fluid contained in the base which supply a potential difference to the flowing fluid.

2. The test cell apparatus of claim 1, further comprising a top member configured to be sealingly coupled to the base for:
interfacing the pair of electrodes to the base; and
for interfacing a fluid supply conduit and a fluid return conduit to the base.

3. The test cell apparatus of claim 2, wherein the base further includes a fluid supply reservoir and a fluid return reservoir, the fluid supply reservoir being in communication with the fluid supply conduit and one of the pair of electrodes, and the fluid return reservoir being in communication with the fluid return conduit and the other one of the pair of electrodes.

4. The test cell apparatus of claim 1, wherein:
the material comprises independent first and second planar material portions; and
further comprising a pair of spacers disposed adjacent the first and second material portions to help channel the flowing fluid across a central portion of the test sample, the working electrode, within the volume.

5. The test cell of claim 4, wherein each spacer includes a central opening an a pair of elongated portions extending out from the central opening to help channel the flowing fluid across the central portion of the test sample, the working electrode.

6. The test cell apparatus of claim 1, wherein the clamp includes a fluid supply passage in communication with the volume, and a fluid return passage in communication with the volume.

7. The test cell apparatus of claim 6, further comprising a gasket configured to be secured between the base and the clamp member to provide a seal there between while permitting the flowing fluid to flow through the fluid supply passage and the fluid return passage in the clamp member.

8. The test cell apparatus of claim 2, further comprising:
a first gasket interposed between the top member and the base for retaining the flowing fluid in the base; and
a second gasket interposed between the clamp member and the base for retaining the flowing fluid through the volume.

9. An electrochemical test cell apparatus for enabling in-situ X-ray transmission of a flowing fluid using a small angle X-ray scattering technique, the apparatus comprising:
a base having a recessed portion that partially defines a volume for containing a test sample, the base having:
a fluid supply reservoir for receiving and containing a portion of a flowing fluid;
a fluid supply passage in communication with the fluid supply reservoir for channeling the flowing fluid from the fluid supply reservoir into the volume;
a fluid return reservoir;
a fluid return passage in communication with the fluid return reservoir for allowing the flowing fluid to exit the volume and flow out to the fluid return reservoir;
a first hole for allowing an X-ray beam to pass through the volume;
a clamp member configured to be sealingly coupled to the base to help define the volume in which the test sample is positioned, the clamp member having a second hole aligned with the first hole in the base for allowing the X-ray beam to pass through the clamp member;
first and second material portions configured to be clamped between the base and the clamp member adjacent the volume to retain the flowing fluid within the volume while allowing passage of the X-ray beam through first and second holes and the volume; and
a pair of electrodes positioned to extend into the fluid supply reservoir and the fluid return reservoir, which supply a potential difference to the flowing fluid.

10. The test cell apparatus of claim 9, further including a pair of cushions configured to be placed between the clamp member and the base to assist in centering the test sample 42 within the recess 44 but more importantly prevents a potential leak path along the working electrode extension that is extending out from between surfaces of the clamp member and the base.

11. The test cell apparatus of claim 10, wherein the base includes an additional fluid supply passage in communication with the fluid supply reservoir, and an additional fluid return passage in communication with the fluid return reservoir.

12. The test cell apparatus of claim 11, wherein the clamp member includes:
a fluid supply passage in communication with the additional fluid supply passage in the base; and
a fluid return passage in communication with the additional fluid return passage in the base.

13. The test cell apparatus of claim 11, wherein the clamp member includes a recess that cooperates in forming the volume, the recess including a fluid supply port in communication with the fluid supply passage in the clamp member, and a fluid return port in communication with the fluid return passage in the clamp member.

14. The test cell of claim 11, further including a pair of spacers clamped between clamp member and the base, within the volume, each of the spacers having a central opening and elongated portions to help promote flow of the flowing fluid over a central area of the test sample.

15. A method for in-situ X-ray transmission through a flowing fluid and a test sample using a small angle X-ray scattering (SAXS) technique, the method comprising:
flowing a fluid into a test cell having a cavity formed therein for containing the test sample, the cavity further including openings through which an X-ray beam may pass to irradiate the flowing fluid while X-ray beam passes through the test sample;
applying a potential difference to the flowing fluid as it enters the test cell;
directing the flowing fluid through the interior cavity, over the test sample positioned within the cavity, and out from the test cell; and
using material sections placed adjacent the cavity that permit passage of the X-ray beam through the cavity and the test sample while sealing the cavity against leakage of the flowing fluid out from the cavity as it flows through the test cell.

16. The method of claim 15, further comprising using a base and a clamp member clamped to the base to form the cavity.

17. The method of claim 16, further comprising using a top member secured to the base to interface a plurality of electrodes to the flowing fluid, the electrodes being used to apply the potential difference to the flowing fluid.

18. The method of claim 16, further comprising:
using a fluid supply reservoir formed in the base to contain a first quantity of the flowing fluid entering the test cell; and
using a fluid return reservoir formed in the base to contain a second quantity of the flowing fluid as it exits the cavity.

19. The method of claim 15, further comprising:
directing the flowing fluid through a pair of fluid supply passages into the cavity, and channeling the flowing fluid out from the cavity through a pair of fluid return passages.

20. The method of claim 19, further comprising:
arranging the pair of fluid supply passages in communication with the cavity such that the pair of fluid supply passages are disposed on opposite sides of the test sample, and
arranging the pair of fluid return passages such that the pair of fluid return passages are disposed on opposite sides of the test sample.
